(19) United States
(12) Patent Application Publication
(10) Pub. No.: US 2025/0056646 A1
(43) Pub. Date: Feb. 13, 2025

(54) METHODS AND APPARATUSES FOR PAGING ENHANCEMENT IN MT-SDT

(71) Applicant: Lenovo (Beijing) Limited, Beijing (CN)

(72) Inventors: Ran Yue, Beijing (CN); Lianhai Wu, Beijing (CN); Jing Han, Beijing (CN); Mingzeng Dai, Shanghai (CN); Min Xu, Beijing (CN)

(73) Assignee: Lenovo (Beijing) Limited, Beijing (CN)

(21) Appl. No.: 18/719,567

(22) PCT Filed: Dec. 17, 2021
(86) PCT No.: PCT/CN2021/139266

§ 371 Date: Jun. 13, 2024

(51) Int. Cl. H04W 76/20; H04W 28/02; H04W 68/02

(52) U.S. Cl. CPC H04W 76/20; H04W 28/0268; H04W 68/02

(57) ABSTRACT

The present application relates to methods and apparatuses for paging enhancement in mobile terminating small data transmission (MT-SDT). One embodiment of the present disclosure provides a first network node, which includes: a processor; a transceiver coupled to the processor, wherein the processor is configured to: receive, via the transceiver, first information associated with mobile terminating small data transmission (MT-SDT) for a user equipment (UE) from a second network node; and determine whether or not to indicate the MT-SDT to the UE based on at least the first information received from the second network node.

### TECHNICAL FIELD

The present disclosure relates to 3^{rd} Generation Partnership Project (3GPP) 5G wireless communication technology, especially to methods and apparatuses for paging enhancement in mobile terminating small data transmission (MT-SDT).

### BACKGROUND OF THE INVENTION

MT-SDT is downlink (DL)-triggered SDT by a paging message without triggering the UE transitioning to RRC_CONNECTED state.

The radio access network (RAN) paging message is used to enable one next generation (NG)-RAN node to request paging of a UE in another NG-RAN node.

If a user equipment (UE) leaves the last serving gNB and camps on a cell controlled by other gNBs within the RAN-based Notification Area (RNA) and the DL small data arrives at the last serving gNB, the existing Xn RAN paging procedure cannot support MT-SDT because it cannot identify the MT-SDT.

### SUMMARY

Therefore, it is desirable to provide a solution for RAN paging enhancement in MT-SDT.

One embodiment of the present disclosure provides a first network node, which includes: a processor; a transceiver coupled to the processor, wherein the processor is configured to: receive, via the transceiver, first information associated with mobile terminating small data transmission (MT-SDT) for a user equipment (UE) from a second network node; and determine whether or not to indicate the MT-SDT to the UE based on at least the first information received from the second network node.

In some embodiments, the first information is included in a RAN paging message from the second network node, or the first information is included in an another message other than the RAN paging message from the second network node.

In some embodiments, the first information associated with the MT-SDT of the UE includes at least one of the following: a first information element indicating a size of downlink data for the UE; one or more second information elements indicating one or more SDT configurations; a third information element indicating the first network node to determine whether to initiate the MT-SDT for the UE; a fourth information element indicating a network node to determine whether to initiate the MT-SDT for the UE; or a fifth information element indicating whether the second network node sends a paging message for the MT-SDT in the second network node or sends a paging message to the UE to initiate a MT-SDT.

In some embodiments, the one or more SDT configurations include at least one of: one or more data radio bearers (DRBs); one or more service types associated with the one or more DRBs; one or more quality of service (QOS) parameters; one or more signaling radio bearer (SRBs); or one or more thresholds associated with SDT.

In some embodiments, the transceiver is further configured to: transmit, to the second network node, second information indicating whether the first network node determines to initiate the MT-SDT for the UE.

In some embodiments, the second information is included in a message for requesting UE context from the second network node via an interface between the first network node and the second network node; or the second information is included in a message other than the message for requesting UE context from the second network node via the interface between the first network node and the second network node.

In some embodiments, the processor is further configured to: determine to initiate the MT-SDT for the UE for a time duration.

Another embodiment of the present disclosure provides a method performed by a first network node, which includes: receiving first information associated with mobile terminating small data transmission (MT-SDT) for a user equipment (UE) from a second network node; and determining whether or not to indicate the MT-SDT to the UE based on at least the first information received from the second network node.

In some embodiments, the first information is included in a RAN paging message from the second network node, or the first information is included in an another message other than the RAN paging message from the second network node.

In some embodiments, the first information associated with the MT-SDT of the UE includes at least one of the following: a first information element indicating a size of downlink data for the UE; one or more second information elements indicating one or more SDT configurations; a third information element indicating the first network node to determine whether to initiate the MT-SDT for the UE; a fourth information element indicating a network node to determine whether to initiate the MT-SDT for the UE; or a fifth information element indicating whether the second network node sends a paging message for the MT-SDT in the second network node or sends a paging message to the UE to initiate a MT-SDT.

In some embodiments, the one or more SDT configurations include at least one of: one or more data radio bearers (DRBs); one or more service types associated with the one or more DRBs; one or more quality of service (QOS) parameters; one or more signaling radio bearer (SRBs); or one or more thresholds associated with SDT.

In some embodiments, the method further includes: transmitting, to the second network node, second information indicating whether the first network node determines to initiate the MT-SDT for the UE.

In some embodiments, the second information is included in a message for requesting UE context from the second network node via an interface between the first network node and the second network node; or the second information is included in a message other than the message for requesting UE context from the second network node via the interface between the first network node and the second network node.

In some embodiments, the method further includes: determining to initiate the MT-SDT for the UE for a time duration.

Still another embodiment of the present disclosure provides a first network node, which includes: a processor; a transceiver coupled to the processor, wherein the processor is configured to: provide first information associated with mobile terminating small data transmission (MT-SDT) for a user equipment (UE); and in the event that the UE is in non-RRC_CONNECTED state, e.g. UE is in RRC_INACTIVE state or RRC_IDLE state, send the first information associated with the MT-SDT for the UE to a second network node via the transceiver, for the second node to decide whether or not to indicate the MT-SDT to the UE.

In some embodiments, the first information is included in a RAN paging message to the second network node, or the first information is included in an another message other than the RAN paging message to the second network node.

In some embodiments, the first information associated with mobile terminating small data transmission MT-SDT includes at least one of the following: a first information element indicating a size of downlink data for the UE; one or more second information elements indicating one or more SDT configurations; a third information element indicating the second network node to determine whether to initiate the MT-SDT for the UE; a fourth information element indicating a network node to determine whether to initiate the MT-SDT for the UE; or a fifth information element indicating whether the first network node sends a paging message for the MT-SDT in the first network node or sends a paging message to the UE to initiate a MT-SDT.

In some embodiments, wherein the one or more SDT configurations include at least one of: one or more data radio bearers (DRBs); one or more service types associated with the one or more DRBs; one or more quality of service (QOS) parameters; one or more signaling radio bearer (SRBs); or one or more thresholds associated with SDT.

In some embodiments, the transceiver is further configured to: receive, from the second network node, second information indicating whether the second network node determines to initiate the MT-SDT for the UE.

In some embodiments, the second information is included in a message for requesting UE context from the second network node via an interface between the first network node and the second network node; or the second information is included in a message other than the message for requesting UE context from the second network node via the interface between the first network node and the second network node.

In some embodiments, the processor is further configured to: determine to initiate the MT-SDT for the UE for a time duration.

Still another embodiment of the present disclosure provides a method performed by a first network node, which includes: providing first information associated with mobile terminating small data transmission (MT-SDT) for a user equipment (UE); and in the event that the UE is in non-RRC_CONNECTED state, sending the first information associated with the MT-SDT for the UE to a second network node, for the second node to decide whether or not to indicate the MT-SDT to the UE.

In some embodiments, the first information is included in a RAN paging message to the second network node, or the first information is included in an another message other than the RAN paging message to the second network node.

In some embodiments, the first information includes at least one of the following: a first information element indicating a size of downlink data for the UE; one or more second information elements indicating one or more SDT configurations; a third information element indicating the second network node to determine whether to initiate the MT-SDT for the UE; a fourth information element indicating a network node to determine whether to initiate the MT-SDT for the UE; or a fifth information element indicating whether the first network node sends a paging message for the MT-SDT in the first network node or sends a paging message to the UE to initiate a MT-SDT.

In some embodiments, the one or more SDT configurations include at least one of: one or more data radio bearers (DRBs); one or more service types associated with the one or more DRBs; one or more quality of service (QOS) parameters; one or more signaling radio bearer (SRBs); or one or more thresholds associated with SDT.

In some embodiments, the method further includes: receiving, from the second network node, second information indicating whether the second network node determines to initiate the MT-SDT for the UE.

In some embodiments, the second information is included in a message for requesting UE context from the second network node via an interface between the first network node and the second network node; or the second information is included in a message other than the message for requesting UE context from the second network node via the interface between the first network node and the second network node.

In some embodiments, the method further includes: determining to initiate the MT-SDT for the UE for a time duration.

### BRIEF DESCRIPTION OF THE DRAWINGS

FIG. 1 illustrates a schematic diagram of a wireless communication system in accordance with some embodiments of the present disclosure.

FIG. 2 illustrates an exemplary Mobile Terminating Early Data Transmission (MT-EDT) for User Plane Cellular Internet of Things (CIoT) Evolved Packet System (EPS) Optimization according to some embodiments of the present disclosure.

FIG. 3 illustrates an exemplary scenario of RAN paging according to some embodiments of the present disclosure.

FIG. 4 illustrates an exemplary method performed by a first network node for wireless communication according to some embodiments of the present disclosure.

FIG. 5 illustrates an exemplary method performed by another network node for wireless communication according to some embodiments of the present disclosure.

FIG. 6 illustrates an exemplary block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

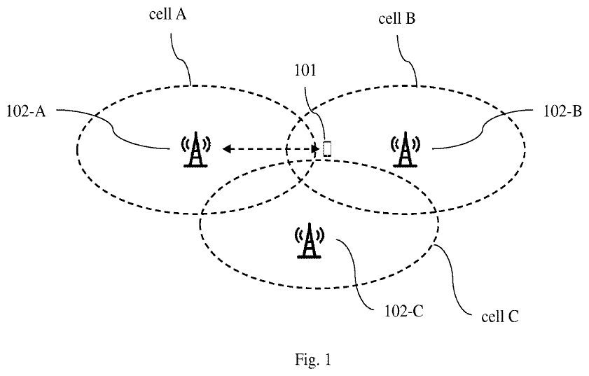

FIG. 1 illustrates a schematic diagram of a wireless communication system in accordance with some embodiments of the present disclosure.

As shown in FIG. 1, the wireless communication system includes UE 101, base station (BS) 102-A, base station 102-B, and base station 102-C. Even though a specific number of UE and BSs are depicted in FIG. 1, person skilled in the art will recognize that any number of UEs and BSs may be included in the wireless communication system.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, UE 101, user terminals, a device, or by other terminology used in the art. The UE 101 may communicate directly with a BS via uplink (UL) communication signals.

The BSs may be distributed over a geographic region. In certain embodiments, a BS may also be referred to as an access point, an access terminal, a base, a base station, a macro cell, a Node-B, an enhanced Node B (eNB), a 5G Base Station uses NR technology, a gNB, a gNodeB, a Home Node-B, a relay node, a device, or by any other terminology used in the art. The BSs are generally part of a radio access network that may include one or more controllers communicably coupled to one or more corresponding BSs.

The wireless communication system is compliant with any type of network that is capable of sending and receiving wireless communication signals. For example, the wireless communication system is compliant with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a LTE network, a 3rd Generation Partnership Project (3GPP)-based network, 3GPP 5G network, a satellite communications network, a high altitude platform network, and/or other communications networks.

In one implementation, the wireless communication system is compliant with the NR of the 3GPP protocol, wherein the BS transmits using an orthogonal frequency division multiplexing (OFDM) modulation scheme on the DL and the UE 101 transmits on the uplink using a single-carrier frequency division multiple access (SC-FDMA) scheme or OFDM scheme. More generally, however, the wireless communication system may implement some other open or proprietary communication protocol, for example, WiMAX, among other protocols.

In other embodiments, the BS may communicate using other communication protocols, such as the IEEE 802.11 family of wireless communication protocols. Further, in some embodiments the BS may communicate over licensed spectrum, while in other embodiments the BS may communicate over unlicensed spectrum. The present disclosure is not intended to be limited to the implementation of any particular wireless communication system architecture or protocol. In another embodiment, the BS may communicate with UE 101 using the 3GPP 5G protocols.

As shown in FIG. 1, suppose there are three cells within the UE's RNA, which are: cell A, cell B, and cell C. Cell A is controlled by BS 102-A, cell B is controlled by BS 102-B, and cell C is controlled by BS 102-C. The UE 101 was served by BS 102-A, and was in RRC_INACTIVE state or in RRC_IDLE state. The UE 101 then left the cell controlled by BS 102-A, and currently camps on cell B which is controlled by BS 102-B.

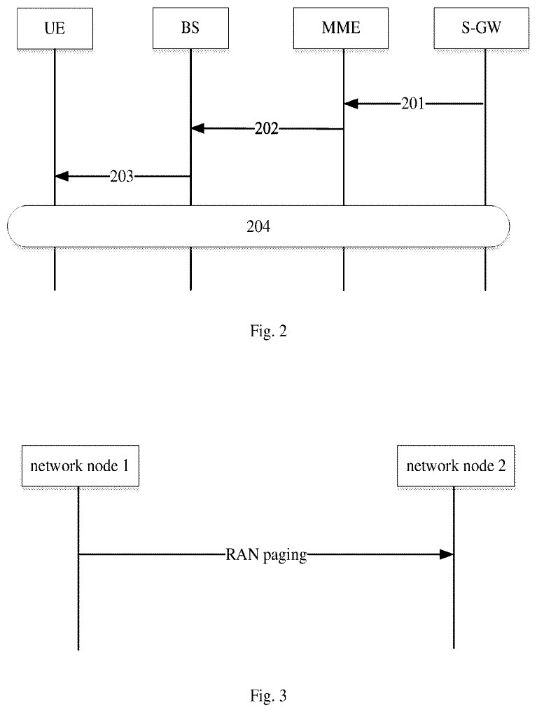

FIG. 2 illustrates an exemplary Mobile Terminating Early Data Transmission (MT-EDT) for User Plane Cellular Internet of Things (CIoT) Evolved Packet System (EPS) Optimization according to some embodiments of the present disclosure.

In FIG. 2, there are 4 components, which include the UE, the BS, the Mobility Management Entity (MME) and the Serving Gateway (S-GW).

In operation 201, upon arrival of downlink data for the UE, the SGW may send the DL data size to the MME for MT-EDT consideration by the MME.

In operation 202, the MME includes the DL data size in the S1-Application Protocol (AP) paging message to assist the BS in triggering MT-EDT.

In operation 203, if the data can fit in one single downlink transmission according to the UE category included in the UE Radio Capability for Paging provided in the S1-AP Paging message, the BS includes MT-EDT indication in the paging message for the UE.

In operation 204, the UE initiates the MO-EDT procedure for the User Plane CIoT EPS Optimization.

Specifically, the following operations may be performed:
1) The UE selects a random access preamble not configured for EDT;
2) The UE sends RRCConnectionResumeRequest message with the resume cause MT-EDT and without user data.
3) The BS initiates the S1-AP Context Resume procedure to resume the S1 connection and re-activate the S1-U bearers.
4) The MME requests the S-GW to re-activate the S1-U bearers for the UE.
5) The MME may include the Pending Data Indication in the S1AP UE Context Resume Response message to notify the BS of further data traffic in excess of that initially signalled in step 2. The BS may use this indication to decide whether to release the UE.
6) The uplink data are delivered to the S-GW.
7) If downlink data are available, the S-GW sends the downlink data to the BS.
8) If no further data are expected, the BS can initiate the suspension of the S1 connection and the deactivation of the S1-U bearers.
9) The BS sends the RRCConnectionRelease message to keep the UE in RRC_IDLE. The message includes the releaseCause set to rrc-Suspend, the resumeID, the NextHopChainingCount and drb-ContinueROHC which are stored by the UE. If downlink data were received in step 6, they are sent ciphered on DTCH multiplexed with the RRCConnectionRelease message on DCCH.

FIG. 3 illustrates an exemplary scenario of RAN paging according to some embodiments of the present disclosure.

FIG. 3 includes two network nodes, which are network node 1 and network node 2. The network nodes may be a NG-RAN node, an eNB, a gNB, a BS, or the like.

The purpose of the RAN paging procedure is to enable the network node 1 to request paging of a UE in the network node 2, and the procedure uses non UE-associated signalling.

The RAN paging procedure is triggered by the network node 1 by sending the RAN paging message to the network node 2, in which the necessary information such as UE RAN Paging Identity should be provided.

If the Paging Priority IE is included in the RAN paging message, the network node 2 may use it to prioritize paging.

If the Assistance Data for RAN Paging IE is included in the RAN paging message, the NG-RAN node 2 may use it.

If the UE Radio Capability for Paging IE is included in the RAN paging message, the network node 2 may use it to apply specific paging schemes.

For MT-SDT, which stands for mobile terminating small data transmission, it refers to DL-triggered SDT by paging message and not transitioning to RRC_CONNECTED, in other words, the small data transmission from the BS to the UE without transitioning the UE to RRC_CONNECTED state.

Currently, the RAN paging message is used to enable one NG-RAN node to request paging of a UE in another NG-RAN node. For example, the RAN paging may be performed by means of Xn RAN paging between nodes which manage the cells within the RAN-based Notification Area (RNA) configured to the UE. For instance, cell A and cell B are within the RNA of a UE, and the Xn RAN paging may be performed between node A (that manages cell A) and node B (that manages cell B).

According to the current specification, if the UE is in RRC_INACTIVE state, the UE may move within the RNA of the UE without notifying NG-RAN. In other words, the UE may be in RRC_INACTIVE state, and it leaves the last serving gNB and camps on a cell controlled by other gNBs within the RNA. Under this scenario, when DL small data arrives at the last serving gNB, the existing Xn RAN paging procedure cannot support MT-SDT, because it cannot identify the MT-SDT. In order to solve this issue, the present disclosure proposes several solutions for paging enhancement in MT-SDT.

### Embodiment 1

In this embodiment, the first gNB, which is not the last serving gNB of the UE, and the first gNB is within the RNA of the UE, determines whether to initiate a MT-SDT for the UE, or initiate a legacy or normal MT call for the UE. For example, in FIG. 1, BS 102-B may determine whether to initiate the MT-SDT for UE 101 or initiate a legacy or normal MT call for UE 101.

The last serving gNB of the UE, i.e. BS 102-A in FIG. 1, may transmit a RAN paging message to BS 102-B and/or BS 102-C, to request paging of UE 101. The following information may be included in the RAN paging message, or included in other messages, or transmitted in a new message.

The message may include at least one of the following information:
1) an information element (IE) associated with the information of the data, which may include at least one of the following:
   i. the DL data size or the DL data volume;
   ii. the DL data is to be transmitted in one shot, i.e. one-shot transmission; or
   iii. the DL data is to be transmitted in multiple shots, i.e. multiple-shot transmission.
2) an information element associated with one or more SDT configurations, which may include at least one of the following:
   i. one or more data radio bearers (DRBs);
   ii. one or more service types associated with the one or more DRBs;
   iii. one or more quality of service (QOS) parameters;
   iv. one or more signaling radio bearer (SRBs); or
   V. one or more thresholds associated with SDT, for example, the threshold configured with the SDT, and/or the value of the threshold for the SDT.
3) an information element indicative of whether the last serving gNB sends a paging message for MT-SDT in the last serving gNB, or in the last serving cell.

After the first gNB determines whether to initiate a MT-SDT for a UE, or initiate a legacy or normal MT call, the first gNB may transmit assistant information to indicate the decision to the last serving gNB via the interface between the first gNB and the last serving gNB, e.g. Xn interface, X2 interface. The assistant information may be referred to “paging for MT-SDT or not,” or the like.

In some scenarios, the assistant information may be included in a message for retrieving UE context, for example, a message that is referred to as: RETRIEVE UE CONTEXT REQUEST message. The assistant information may be included in the message as a new information element, or an additional information element, or reuse an existing information element in the message.

In some other scenarios, instead of being included in other messages, the assistant information may be transmitted in a new message from the first gNB to the lasting serving gNB via the interface between the first gNB and the last serving gNB.

In still other scenarios, if the first gNB does not transmit the assistant information to the last serving gNB, it means the first gNB will not initiate a MT-SDT for the UE. That is, the first gNB may initiate a legacy or normal MT call. Or if the first gNB does not transmit the assistant information to the last serving gNB, it means the first gNB will initiate a MT-SDT for the UE.

It should be noted that in some cases, the last serving gNB, may send a RAN paging message for MT-SDT in the last serving gNB, the first gNB may take the RAN paging message for MT-SDT transmitted by the last serving gNB into consideration, and the determination will be made by taking into other elements into consideration as well. For example, the UE capability of the UE, the capability of the first gNB itself, the latency requirements, etc. If the criterion for initiating the MT-SDT is satisfied, the first gNB may send a paging message for MT-SDT to the UE. In some other scenarios, if some criterion for initiating the MT-SDT cannot be fulfilled, the first gNB may initiate a normal MT call for the UE.

### Embodiment 2

In this embodiment, the first gNB, which may be the last serving gNB of the UE, determines which network node (which may be referred to the second gNB) is responsible for deciding the paging type. In other words, the last serving gNB may indicate the second gNB, which is within the UE's RNA, to determine whether to initiate a MT-SDT for a UE, or initiate a legacy or normal MT call for the UE. For example, in FIG. 1, BS 102-A, which is the last serving gNB of the UE, may determine that it is BS 102-B to determine whether to initiate the MT-SDT for UE 101 or initiate a legacy or normal MT call for MT for UE 101.

The last serving gNB of the UE, i.e. BS 102-A in FIG. 1, may transmit a RAN paging message to BS 102-B and/or BS 102-C, to request paging of UE 101. The following information may be included in the RAN requesting message, or included in other messages, or transmitted in a new message.
1) An information element indicating which network node to decide the paging type.
For example, if the value of the IE is “1,” “y,” “Y,” or “yes”, or the like, it means it is the network node which receives the message is to decide the paging type, i.e. whether to initiate a MT-SDT for the UE, or initiate a legacy or normal MT call for the UE.
If the value of the IE is “0,” “n,” “N,” or “no”, or the like, it means the network node which receives the message is not to decide the paging type. In this case, the paging type may be determined by the last serving gNB, or other gNBs.
In some other cases, the value of the IE is “1” means that the last serving node will determine the paging type, and the value of the IE is “0” means that other network nodes will determine the paging type.
It should be noted that the meaning of the value of the IE could be defined in other manners, and the present disclosure has no intention of limiting the meaning of the value of the IE.
2) An information element associated with the information of the data, which may include at least one of the following:
   i. the DL data size or the DL data volume;
   ii. the data is to be transmitted in one shot, i.e. one-shot transmission; or
   iii. the data is to be transmitted in multiple shots, i.e. multiple-shot transmission.
The value of the IE may also indicate which network node to decide the information of the data. For example, the value of the IE being “0” means the last serving gNB determines the information of the data, and the value of the IE being “1” means the second gNB that receives this message (which includes the IE) will determine the information of the data.
In this embodiment, the information element associated with the information of the data may or may not be transmitted from the last serving gNB.
3) an information element associated with one or more SDT configurations, which may include at least one of the following:
   i. one or more DRBs;
   ii. one or more service types associated with the one or more DRBs;
   iii. one or more QoS parameters;
   iv. one or more SRBs; or
   V. one or more thresholds associated with SDT, for example, the threshold configured with the SDT, and/or the value of the threshold for the SDT.
The value of the IE may also indicate which network node to decide the one or more SDT configurations. For example, the value of the IE being “0” means the last serving gNB determines the SDT configurations; and the value of the IE being “1” means the second gNB that receives this message (which includes the IE) will determine the SDT configurations.
In this embodiment, the information element associated with the SDT configurations may or may not be transmitted from the last serving gNB.
4) An information element indicating whether the last serving gNB sends the paging message for MT-SDT.
For example, the value of the IE being “0” indicates that the last serving gNB does not send the paging message for MT-SDT, and the value of the IE being “1” indicates that the last serving gNB sends the paging message for MT-SDT, and vice versa.
Alternatively, the value of the IE being “0” indicates that the last serving gNB sends the paging message for normal MT call, and the value of the IE being “1” indicates that the last serving gNB sends the paging message for MT-SDT, and vice versa.

In the case that the last serving gNB indicates the second gNB (for example, BS 102-B in FIG. 1) to determine the paging type, the BS 102-B may transmit assistant information to indicate the decision of the paging type. The assistant information may be referred to “paging for MT-SDT or not,” “paging for MT-SDT or for normal MT call,” “paging type,” or the like.

In the case that the last serving gNB indicates other gNB that it is the last serving gNB itself that will determine the paging type, the other gNBs may not transmit the assistant information to the last serving gNB.

In some scenarios, the assistant information may be included in a message for retrieving UE context, for example, a message that is referred to as: RETRIEVE UE CONTEXT REQUEST message. The assistant information may be included in the message as a new information element, or an additional information element, or reuse an existing information element in the message.

In some other scenarios, instead of being included in other messages, the assistant information may be transmitted in a new message from the second gNB to the lasting serving gNB via the interface between the second gNB and the last serving gNB.

In some cases, the last serving gNB that receives the assistant information, may transfer a part of the UE context, for example, only the SDT DRBs related context.

### Embodiment 3

In this embodiment, the first gNB, which may be the last serving gNB of the UE, determines whether to initiate a MT-SDT for a UE, or initiate a legacy or normal MT call for the UE. For example, in FIG. 1, BS 102-A, which is the last serving gNB of the UE, determines whether to initiate the MT-SDT for UE 101 or initiate a legacy or normal MT call for UE 101.

The last serving gNB may transmit a message including at least one of the following information elements to other gNBs within the UE's RNA:
1) an information element indicating whether the other BSs initiate a MT-SDT for the UE by sending a paging message for MT-SDT.
For example, the value of the IE being “1” indicates that the other BSs should initiate a MT-SDT for the UE. The value of the IE being “0” indicates that the other BSs should not initiate a MT-SDT for the UE, or vice versa.
Taking the scenario in FIG. 1 as an example, the last serving gNB, BS 102-A in FIG. 1, indicates BS 102-B to initiate a MT-SDT for UE 101. BS 102-B should take this indication into consideration, to determine whether to initiate a MT-SDT for UE 101. If the requirements for initiating the MT-SDT are satisfied, BS 102-B sends a paging message for MT-SDT for UE 101. In some other scenarios, if some requirements for initiating the MT-SDT cannot be fulfilled, BS 102-B may initiate a normal MT call for UE 101.
2) an information element indicating whether the last serving gNB sends a paging message for MT-SDT.
For example, the value of the IE being “0” indicates that the last serving gNB does not send the paging message for MT-SDT, and the value of the IE being “1” indicates that the last serving gNB sends the paging message for MT-SDT, and vice versa.
Alternatively, the value of the IE being “0” indicates that the last serving gNB sends the paging message for normal MT call, and the value of the IE being “1” indicates that the last serving gNB sends the paging message for MT-SDT, and vice versa.

### Embodiment 4

In this embodiment, the last serving gNB and/or the other gNBs (or cells) within the UE's RNA apply the same strategy for paging type. That is, all the gNBs (or cells) within the UE's RNA sends paging message for MT-SDT, and the decision may be applied to one MT-SDT, or to all of the MT-SDTs, or applied for a time duration. Alternatively, all the gNBs (or cells) within the UE's RNA sends paging message for a normal MT call, and the decision may be applied to one MT-SDT, or to all of the MT-SDTs, or applied for a time duration. The strategy for paging type can be specified or pre-defined or indicated by a control node.

The last serving gNB of the UE, determines whether to initiate a MT-SDT for a UE, or initiate a legacy or normal MT call. For example, in FIG. 1, BS 102-A, which is the last serving gNB of the UE, determines whether to initiate the MT-SDT for UE 101 or initiate a legacy or normal MT call for UE 101.

In this embodiment, the last serving gNB may transmit a message including the same information as mentioned in embodiment 3.

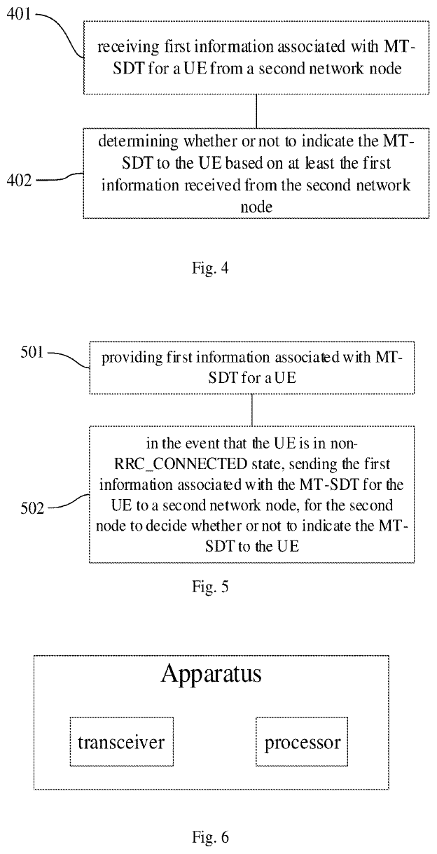

FIG. 4 illustrates an exemplary method performed by a first network node for wireless communication according to some embodiments of the present disclosure.

In operation 401, the first network node receives first information associated with MT-SDT for a UE from a second network node; and in operation 402, the network node determines whether or not to indicate the MT-SDT to the UE based on at least the first information received from the second network node. For example, taking FIG. 1 as an example, UE 101 is in RRC_IDLE state or RRC_INACTIVE state, the UE's RNA includes cell A, cell B, and cell C. BS 102-B may receive the first information associated with MT-SDT for UE 101 from BS 102-A, and BS 102-B determines whether to initiate the MT-SDT for UE 101 at least based on the first information, which is received from BS 102-A.

The first information may be included in the RAN paging message from the second network node, or the first information is included in an another message other than the RAN paging message from the second network node.

The first information associated with the MT-SDT of the UE includes at least one of the following:
1) a first information element indicating a size of downlink data for the UE;
2) one or more second information elements indicating one or more SDT configurations;
3) a third information element indicating the first network node to determine whether to initiate the MT-SDT for the UE;
4) a fourth information element indicating a network node to determine whether to initiate the MT-SDT for the UE. It should be noted that the network node includes any networks nodes within the RNA of the UE, including the last serving node. For example, the last serving node may transmit the first information to other nodes within the RNA of the UE, to indicate that the last serving node is to determine whether to initiate the MT-SDT for the UE or not. or
5) a fifth information element indicating whether the second network node sends a paging message for the MT-SDT in the second network node or sends a paging message to the UE to initiate a MT-SDT.

In some embodiments, the one or more SDT configurations may include at least one of: one or more DRBs; one or more service types associated with the one or more DRBs; one or more QoS parameters; one or more SRBs; or one or more thresholds associated with SDT.

In some cases, the first network node may transmit, to the second network node, second information indicating whether the first network node determines to initiate the MT-SDT for the UE. For example, after determining whether to initiate the MT-SDT for UE 101, BS 102-B may transmit the decision of whether to initiate the MT-SDT to BS 102-A.

In some embodiments, the second information is included in a message for requesting UE context from the second network node via an interface between the first network node and the second network node; or the second information is included in a message other than the message for requesting UE context from the second network node via the interface between the first network node and the second network node. For example, the second information may be included in the message such as “RETRIEVE UE CONTEXT REQUEST” message, or other messages, via the Xn interface, or X2 interface between the gNBs.

In some embodiments, the first network node determines to initiate the MT-SDT for the UE for a time duration. That is to say, within the time duration, the first network node always initiates the MT-SDT for the UE.

FIG. 5 illustrates an exemplary method performed by another network node for wireless communication according to some embodiments of the present disclosure.

In operation 501, the network node provides first information associated with MT-SDT for a UE; and in operation 502, in the event that the UE is in non-RRC_CONNECTED state, the network node sends the first information associated with the MT-SDT for the UE to a second network node via the transceiver, for the second node to decide whether or not to indicate the MT-SDT to the UE.

Taking FIG. 1 as an example, UE 101 is in RRC_IDLE state or RRC_INACTIVE state, which is non-RRC_CONNECTED state, the UE's RNA includes cell A, cell B, and cell C. BS 102-A may provide first information associated with MT-SDT for a UE, and sends the first information to BS 102-B. Here the term “provide” suggests that BS 102-A may provide necessary information and include it in the first information, then transmit the first information to BS 102-B.

FIG. 6 illustrates an exemplary block diagram of an apparatus according to some embodiments of the present disclosure.

The apparatus may be or include at least a part of a BS, a gNB, an eNB, or other device with similar functionality.

The apparatus may include a processor and a transceiver coupled with the processor. In some embodiments, the transceiver may include a transmitter and a receiver. The processor is configured to perform any of the methods described in the present disclosure, for example, the method described with respect to FIGS. 4 and 5. For example, when the apparatus is implemented a network node instead of the last serving node, the receiver may receive, via the transceiver, first information associated with MT-SDT for a UE from a second network node; and the processor may determine whether or not to indicate the MT-SDT to the UE based on at least the first information received from the second network node.

When the apparatus is implemented as the last serving node, the processor may provide first information associated with MT-SDT for a UE, and in the event that the UE is in non-RRC_CONNECTED state, send the first information associated with the MT-SDT for the UE to a second network node via the transceiver, for the second node to decide whether or not to indicate the MT-SDT to the UE.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first network node, comprising:
at least one memory; and
at least one processor coupled with the at least one memory and configured to cause the first network node to:
receive, from a second network node, first information associated with mobile terminating small data transmission (MT-SDT) for a user equipment (UE); and
determine whether or not to indicate the MT-SDT to the UE based on at least the first information received from the second network node.

2. The first network node of claim 1, wherein the first information is included in a radio access network (RAN) paging message from the second network node, or the first information is included in another message other than the RAN paging message from the second network node.

3. The first network node of claim 1, wherein the first information associated with the MT-SDT of the UE includes at least one of:
a first information element indicating a size of downlink data for the UE;
one or more second information elements indicating one or more SDT configurations;
a third information element indicating the first network node to determine whether to initiate the MT-SDT for the UE;
a fourth information element indicating a network node to determine whether to initiate the MT-SDT for the UE; or
a fifth information element indicating whether the second network node sends a paging message for the MT-SDT in the second network node or sends the paging message to the UE to initiate the MT-SDT.

4. The first network node of claim 3, wherein the one or more SDT configurations include at least one of:
one or more data radio bearers (DRBs);
one or more service types associated with the one or more DRBs;
one or more quality of service (QOS) parameters;
one or more signaling radio bearer (SRBs); or
one or more thresholds associated with SDT.

5. The first network node of claim 1, wherein the at least one processor is configured to cause the first network node to transmit, to the second network node, second information indicating whether the first network node determines to initiate the MT-SDT for the UE.

6. The first network node of claim 5, wherein:
the second information is included in a message for requesting UE context from the second network node via an interface between the first network node and the second network node; or
the second information is included in a message other than the message for requesting the UE context from the second network node via the interface between the first network node and the second network node.

7. The first network node of claim 1, wherein the at least one processor is configured to cause the first network node to determine to initiate the MT-SDT for the UE for a time duration.

8. A method performed by a first network node, comprising:
receiving, from a second network node, first information associated with mobile terminating small data transmission (MT-SDT) for a user equipment (UE); and
determining whether or not to indicate the MT-SDT to the UE based on at least the first information received from the second network node.

9. A first network node, comprising:
at least one memory; and
at least one processor coupled with the at least one memory and configured to cause the first network node to:
provide first information associated with mobile terminating small data transmission (MT-SDT) for a user equipment (UE); and
if the UE is in a non-RRC_CONNECTED state, send the first information associated with the MT-SDT for the UE to a second network node that determines whether or not to indicate the MT-SDT to the UE.

10. The first network node of claim 9, wherein the first information is included in a radio access network (RAN) paging message to the second network node, or the first information is included in another message other than the RAN paging message to the second network node.

11. The first network node of claim 9, wherein the first information associated with the MT-SDT includes at least one of:
a first information element indicating a size of downlink data for the UE;
one or more second information elements indicating one or more SDT configurations;
a third information element indicating the second network node to determine whether to initiate the MT-SDT for the UE;
a fourth information element indicating a network node to determine whether to initiate the MT-SDT for the UE; or
a fifth information element indicating whether the first network node sends a paging message for the MT-SDT in the first network node or sends the paging message to the UE to initiate the MT-SDT.

12. The first network node of claim 11, wherein the one or more SDT configurations include at least one of:
one or more data radio bearers (DRBs);
one or more service types associated with the one or more DRBs;
one or more quality of service (QOS) parameters;
one or more signaling radio bearer (SRBs); or
one or more thresholds associated with SDT.

13. The first network node of claim 9, wherein the at least one processor is configured to cause the first network node to receive, from the second network node, second information indicating whether the second network node determines to initiate the MT-SDT for the UE.

14. The first network node of claim 13, wherein:
the second information is included in a message for requesting UE context from the second network node via an interface between the first network node and the second network node; or
the second information is included in a message other than the message for requesting the UE context from the second network node via the interface between the first network node and the second network node.

15. The first network node of claim 9, wherein the at least one processor is configured to cause the first network node to determine to initiate the MT-SDT for the UE for a time duration.

16. The method of claim 8, wherein the first information is one of included in a radio access network (RAN) paging message from the second network node, or included in another message other than the RAN paging message from the second network node.

17. The method of claim 8, wherein the first information associated with the MT-SDT of the UE includes at least one of:
a first information element indicating a size of downlink data for the UE;
one or more second information elements indicating one or more SDT configurations;
a third information element indicating to determine whether to initiate the MT-SDT for the UE;
a fourth information element indicating a network node to determine whether to initiate the MT-SDT for the UE; or
a fifth information element indicating whether the second network node sends a paging message for the MT-SDT in the second network node or sends the paging message to the UE to initiate the MT-SDT.

18. The method of claim 8, further comprising:
transmitting, to the second network node, second information indicating whether the first network node determines to initiate the MT-SDT for the UE.

19. The method of claim 8, further comprising:
determining to initiate the MT-SDT for the UE for a time duration.

20. A processor for wireless communication, comprising:
at least one controller coupled with at least one memory and configured to cause the processor to:
receive, from a network node, first information associated with mobile terminating small data transmission (MT-SDT) for a user equipment (UE); and
determine whether or not to indicate the MT-SDT to the UE based on at least the first information received from the network node.
